(19) United States
(12) Patent Application Publication
(10) Pub. No.: US 2018/0313379 A1
(43) Pub. Date: Nov. 1, 2018

(54) DEVICE FOR HOLDING BACK A COMPONENT

(71) Applicant: A. Raymond et Cie. SCS, Grenoble (FR)

(72) Inventors: Stefan Schulz, Lörrach (DE); Melanie Anna, Hausen im Wiesental (DE); Virginie Pouzols, Huningue (FR); Julien Friedl, Waldighoffen (FR)

(73) Assignee: A. Raymond et Cie. SCS, Grenoble (FR)

(21) Appl. No.: 15/578,733

(22) PCT Filed: May 31, 2016
(86) PCT No.: PCT/EP16/00890

§ 371 Date: Dec. 1, 2017

(30) Foreign Application Priority Data
Jun. 1, 2015 (DE) 102015210063.4
Jun. 1, 2015 (DE) 102015210092.8

(51) Int. Cl. F16B 5/06; F16B 2/24; F16B 21/08

(52) U.S. Cl. CPC F16B 5/065; F16B 21/086; F16B 5/0664; F16B 2/243

(57) ABSTRACT

The Invention relates to a device (1, 101, 201) for restraining a component (11, 111, 211), wherein the device has a carrier part (2, 102, 202) and a clip part (3, 103, 203), and the clip part (3, 103, 203 is connected to the carrier part (2, 102, 202), and the clip part (3, 103, 203) has at least one clip surface (7, 107, 207), which is connected to an engagement section (9, 109, 209) of the clip part (3, 103, 203), wherein the engagement section (9, 109, 209) extends away from the carrier part (2, 102, 202) in the direction of a central axis (M), and wherein the clip surface (7, 107, 207) at least essentially faces the carrier part, wherein it is provided that the engagement section (9, 109, 209) is movable in the direction of the central axis (M) relative to the carrier part (2, 102, 202), and a deflection surface (14, 214) is formed on the engagement section (9, 209) and is aligned at an angle to the central axis (M), wherein the deflection surface (14, 214) contacts a protrusion on the carrier part (2, 202), and the protrusion slides along the deflection surface (14, 214) when the engagement section (9, 209) is moved relative to the carrier part (2) in the direction of the central axis (M), such that a movement of the clip surface (7) connected to the engagement section (9) in the direction toward the central axis (M) or away from the central axis (M) is induced, and/or a deflection surface (114) is formed on the carrier part (102) and is aligned at an angle to the central axis (M), wherein the deflection surface (114) contacts a finger (124) on the engagement section (109), and the finger (124) slides along the deflection surface (114) when the engagement section (109) is moved in the direction of the central axis (M) relative to the carrier part (102), thereby inducing a movement of the clip surface (107), which is connected to the engagement section (109), in the direction toward the central axis (M) or away from the central axis (M).

The invention relates to a device for restraining a component.

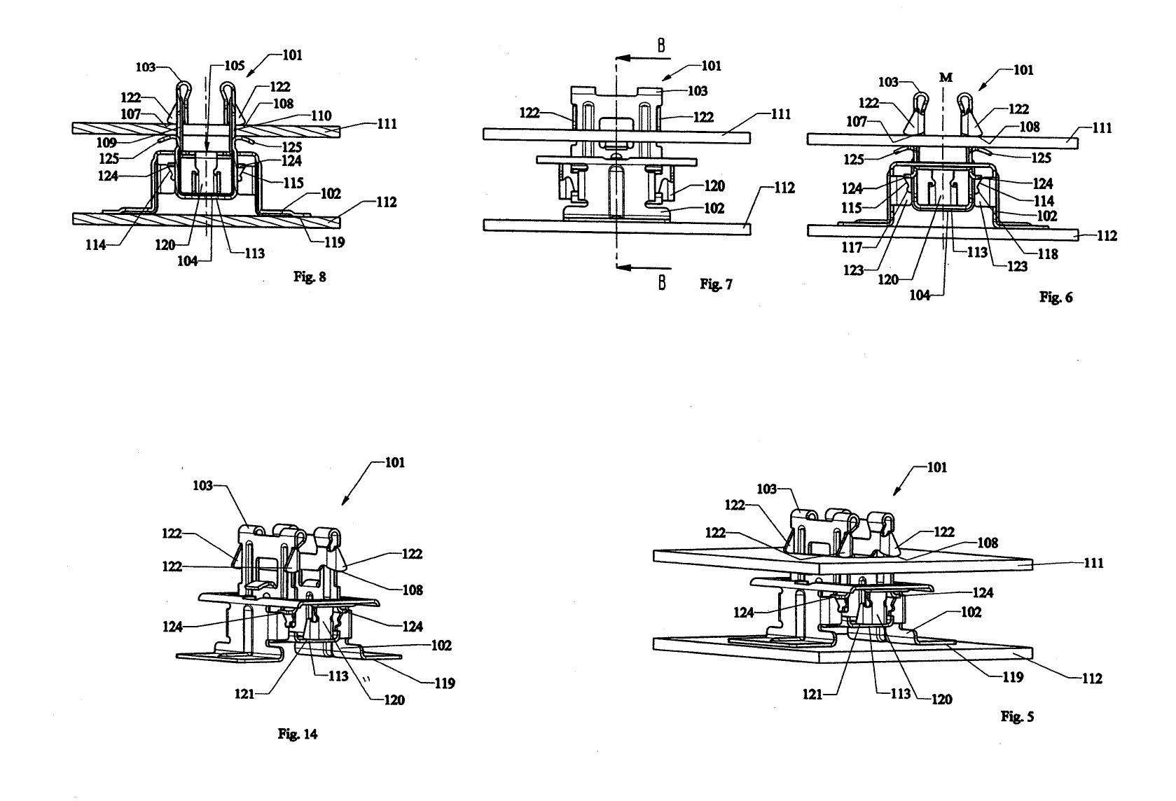

A device for restraining a component is known from US 2011/0209309 A1. The device described there has a clip part which has two clip surfaces arranged opposite one another with respect to a central axis. As shown in FIG. 5 and FIG. 6 of US 2011/0209309 Al, the clip surfaces 23 of the device described there are designed so that they face in the direction of a base body 20. The device described there may be used to restrain the component 19 shown in FIGS. 5 and 6 in relation to the base body 20. To do so, the device described there is connected to a web 27 of the base body 20. Next, the component 19 is pushed onto the device and the base body 20, wherein the device passes through a recess in the component 19. Engagement sections to which the chip surfaces are attached are prestressed by spring elasticity in the position illustrated in FIG. 4. During the insertion thereof into the hole the clip surfaces are moved in the direction of the central axis so that the outer cross section of the device is reduced in the region of the clip surfaces. After passing through the recess in the component 19 and because of the prestress on the engagement sections, the clip surfaces spring back into the positions shown in FIGS. 5 and 6, where they restrain the component 19 in relation to the base body 20 in such a way that the component 19 cannot continue to move downward in the direction away from the base body 20 in FIG. 5.

US 2013/0183089 A1 also discloses a device for restraining components 9, 40, 41 with respect to a base body 29. The component described there has a carrier part 22 and a clip part which is connected to the carrier part 22. The clip part has a clip surface 9 which is connected to an engagement section of the clip part, wherein the engagement section extends away from the carrier part in the direction of the central axis. The clip surface 9 points at least essentially to the carrier part 22.

Against this background, the object of the invention was to create a device for restraining a component which will ensure a secure retention of the component but at the same time will offer the possibility of releasing the restrained component.

This object is achieved by the device according to claim 1. Advantageous embodiments are defined in the dependent claims and in the following description here.

The invention is aimed at the basic idea of designing the engagement section relative to the carrier part in the direction of the central axis and using this mobility by the use of deflection surfaces so that the clip surface connected to the engagement section can be moved in the direction toward the central axis or the direction away from the central axis. The device according to the invention therefore offers the possibility of restraining the component through contact of the chip surface with the component, but at the same time also offering the possibility of moving chip surface in a direction that releases the restrained component by moving the engagement section relative to the carrier part.

To achieve this effect, the invention operates with a deflection surface aligned in an angle to the central axis. The deflection surface is provided on one of the two parts that are movable relative to one another and cooperates with a protrusion on the other one of the two parts that are movable relative to one another. If the two parts are moved relative to one another, then the protrusion on the one part slides along the deflection surface of the other part. A movement perpendicular to the central axis is induced by the protrusion sliding along the deflection surface because the deflection surface is aligned at an angle to the central axis and therefore at an angle to the direction of movement of the two parts relative to one another. This movement perpendicular to the central axis can be utilized to achieve a movement of the clip surface in the direction toward the central axis or away from the central axis.

In a first specific embodiment, the deflection surface is embodied on the engagement section. It is aligned at an angle to the central axis and contacts a protrusion on the carrier part. This contact with the protrusion on the carrier part occurs at least when the engagement section is moved relative to the carrier part in the direction of the central axis, in particular onto the carrier part in the direction of the central axis. Conceivable designs also include those in which the deflection surface is not initially in contact with the protrusion on the carrier part, and the engagement section having the deflection surface must initially be moved over a certain distance toward the carrier part in the direction of the central axis until the deflection surface then contacts the protrusion on the carrier part. The movement of the engagement section in the direction of the central axis then leads further to the fact that the protrusion slides along the deflection surface.

In a preferred specific embodiment, the design of the protrusion on the carrier part is rigid while the section of the engagement section having the deflection surface is movable within the clip part. A movable embodiment of the engagement section is also understood to be one in which the engagement section is moved out of a normal position against a prestressing force and returns back into the normal position after the acting force has been eliminated. The sliding of the protrusion on the carrier part along the deflection surface of the engagement section then causes the section of the engagement part having the deflection surface to move away from the protrusion in the direction perpendicular to the central axis. It is then possible to adjust, through the construction based on the orientation of the deflection surface, whether, with a movement of the engagement section in the direction of the central axis, this section of the engagement section should move toward the central axis in the direction of the central axis or away from the central axis. If the deflection surface is arranged in such a way that it tends to run in the direction of the carrier part toward the central axis and is a greater distance away from the central axis when the distance from the carrier part increases, then the sliding of the protrusion on the carrier part moves along the deflection surface when the protrusion is arranged rigidly on the carrier part and there is a relative movement of the clip part toward the carrier part, such that the section of the engagement section having the deflection surface is moved toward the central axis. However, if the deflection surface is arranged in such a way that it runs away from the central axis in the direction of the carrier part and is increasingly closer to the central axis with an increase in the distance from the carrier part, then the sliding of the protrusion on the carrier part moves along the deflection surface when the protrusion is rigidly disposed on the carrier part and there is a relative movement of the clip part toward the carrier part, such that the section of the engagement section having the deflection surface is moved away from the central axis.

In such a specific embodiment, if the clip surface is attached to the engagement section without any intermediate joints or force deflection points, then the interaction between the protrusion and the deflection surface described in the preceding paragraph causes the clip surface to also be moved in the direction of the central axis.

The basic idea according to the invention can be implemented by designing the deflection surface on the carrier part and arranging it at an angle to the central axis. In this specific embodiment, the deflection surface contacts a protrusion on the engagement section, which is also referred to below as a “finger” to facilitate a differentiation without implying any particular geometric shape of the protrusion to be provided on the engagement section for cooperating with the deflection surface of the carrier part. With the specific embodiment described here, the finger of the engagement section slides along the deflection surface of the carrier part when the engagement section is moved relative to the carrier part in the direction of the central axis, in particular preferably being moved toward the carrier part. If the deflection surface is rigidly formed on the carrier part and the portion of the engagement section having the finger is embodied movably inside the clip part, then the sliding of the finger on the engagement section along the deflection axis of the carrier part causes the portion of the engagement section carrying the finger to yield when the engagement section is moved relative to the carrier part in the direction of the central axis. Due to this yielding, this portion of the engagement section can be moved toward or away from the central axis depending on the orientation of the deflection surface on the carrier part. If the clip surface is connected to the portion of the engagement section having the finger without any joint or any other means for deflecting the force, then any movement of the portion of the engagement section having the finger perpendicular to the central axis will at the same time cause a movement of the clip surface in the same direction.

The two possible implementations of the idea according to the invention described above can be combined with one another. Thus, in some conceivable specific embodiments, a deflection surface is embodied on the engagement section, which then cooperates with a protrusion on the carrier part, while a deflection surface is also provided on the carrier part, which cooperates with a finger on the engagement section. The combination of these two effects may make it possible to create an effective force from the movement of the engagement section relative to the carrier part such that the clip surface is moved in the direction toward the central axis or away from the central axis while at the same time a compact design shape can be achieved, for example, when the respective deflection surfaces are provided on independent flat portions of the engagement section and/or of the carrier part arranged side by side. The load on a deflection surface can be reduced by the multitude of deflection surfaces.

There are also conceivable specific embodiments in which the protrusion on a carrier and/or the finger is/are formed on the engagement section as an inclination so that the deflection surface aligned at an angle to the central axis cooperates with a surface on the carrier part and/or on the engagement section which is also aligned at an angle to the central axis. In this way the force to be transferred is distributed over a larger area. There is no spot load at the spot of interaction of the deflection surface with the protrusion and/or the finger when the surface of the protrusion and/or the surface of the finger is/are embodied as an inclined surface.

The invention relates to a device for restraining a component. This suitability is achieved when the device according to the invention itself can be connected to a base body and, because of its design, another component can be restrained in relation to the base body. “Restraining” is understood to refer to preventing movement of the component in a direction relative to the base body. For example, the component should be prevented from being a greater distance away from the base body than a certain defined position. Then the question that remains open for the invention is whether the device prevents only movement of the component in a direction relative to the base body and, for example, allows the component to move in the opposite direction toward the base body or whether the device has the capability of preventing movement of the component in a first direction and also preventing the opposite movement relative to the base body. In a preferred specific embodiment, which is described further below, it is provided that the device according to the invention is to be attached to a base body, for example, by gluing or welding it onto the base body, and the component to be restrained is to be restrained by means of the device on this base body in such a way that it cannot move away from the base body in any direction.

The suitability for restraining a component in the case of the device according to the invention is derived from the clip surface and its orientation relative to the carrier part. The device according to the invention has a carrier part and a clip part, wherein the clip part is connected to the carrier part. The clip part has a clip surface which faces essentially the carrier part. The object of the clip surface is to restrain the component that is to be restrained. The component to be restrained abuts against the clip surface. Since the slip surface essentially faces the carrier part, the abutment of the component to be restrained against the clip surface prevents the component from being able to move a greater distance away from the carrier part. If the carrier part is connected to the base body, this basic design of the device according to the invention allows the component to be restrained relative to the base body. The precise shape of the clip surface may be determined by the type of component that is to be restrained. It is to be expected that a particularly good restraining effect is achieved when the clip surface is perpendicular to the direction in which the component should not move. This achieves the maximum blockade effect. In a particularly preferred specific embodiment, if the direction in which the component should not move and the central axis coincide, then the clip surface is embodied at a right angle to the central axis. However, it is conceivable for the clip surface to stand at an angle to the direction in which the component should not move. This makes it possible to achieve additional effects. For example, there are conceivable specific embodiments, in which the clip surface is passed through an opening in the component or must be passed by a side surface of the component and then, after passing by an edge of the component, recoils into the normal position because of a prestressing force acting on the engagement section when the component and the base body are joined together. This recoil is simplified if the clip surface is designed at an angle to the direction in which it should prevent the movement of the component. Furthermore, the angular embodiment of the clip surface allows manufacturing tolerances to be bridged. If the clip surface is embodied at a 90° angle to the direction into which it should prevent the movement of the component then it is necessary to ensure on the basis of manufacturing tolerances that in the specific embodiment described here the clip surface can in fact pass by the edge of the component and can snap back into its normal position. It is therefore necessary to ensure that the edge of the component is so far away from the base body that the clip surface can in fact spring back into its normal position. In the case of a clip surface embodied at an oblique angle, the clip surface slides over a certain region along the edge of the component. This at least permits partial spring-back into a normal position of the clip surface even if the position of the edge relative to the base body is not embodied perfectly.

In particular, a clip surface is preferably also understood to be facing at least essentially toward the carrier part when its surface normal is at an angle of 45° to the central axis of the carrier part.

The clip part is connected to the carrier part. At the same time, the engagement section embodied as part of the clip part is movable relative to the carrier part in the direction of the central axis. In a preferred specific embodiment, this can be achieved by the fact that the carrier part and the clip part are embodied as independent parts of the device according to the invention. These two components can then be joined to one another, for example, by means of snap connection. In the case of a snap connection, a protrusion on one component engages behind a protrusion on the other component. This snap connection holds the one component on the other component with respect to movements in one direction, namely the direction bringing the protrusions together. In the opposite direction however a relative movement is possible. In other specific embodiments, the clip part and the carrier part are joined to one another by means of an elastic element. This type of connection also ensures that the clip part cannot be moved away from the carrier part in a first direction beyond an extent determined by the elastic connection, while the elastic connection at the same time allows movement of the engagement section relative to the carrier part, namely in the direction opposite the first direction.

The clip part of the device according to the invention has an engagement section. The clip surface is connected to this engagement section. At the same time, the engagement section extends away from the carrier part in the direction of the central axis. In a particularly preferred specific embodiment, the central axis is the axis in the direction of which the device according to the invention should prevent the component from moving, i.e., should restrain it. In the particularly preferred fields of use of the device according to the invention, the component that is restrained is moved relative to the base body into a position in which it should be restrained. In particularly preferred fields of application, this takes place in that the clip surface and at least the part of the engagement section on which the clip surface is situated are moved relative to the component, namely in particular preferably being moved past the component to be restrained until the clip surface has passed by an edge of the component. The device according to the invention should preferably make it possible in particular for the clip surface and the portion of the engagement section connected to it to be movable through a hole in the component being restrained, and for the clip surface, after having come out of the hole, to snap back into the normal position. For these particularly preferred fields of use, it is especially advantageous for the engagement section to extend away from the carrier part. This results in the possibility of embodying the clip part and in particular the engagement section of the clip part as rather elongated parts, so that good insertion into a hole in a component is made possible, whereas additionally or alternatively, the carrier part can be embodied more in the width, in order to enable a good connection of the carrier part to the base body.

The engagement section extends away from the carrier part in the direction of a central axis. The term “engagement section” is understood broadly within the scope of this description and the claims. The section of the clip part identified in this way includes not only the part of the clip part to which the clip surface is connected but also the part of the clip part on which the deflection surface is embodied. The section of the clip part identified in this way may also include a section extending beyond the deflection surface further in the direction of the carrier part. The fact that this requires that the engagement section must extend in the direction of a central axis away from the carrier part does not rule out the fact that parts of the engagement section are also designed at the level of the carrier part or even inserted into the carrier part, for example, into a hole in the carrier part. The engagement section should be understood to be that part of the clip part that is deflected out of the normal position by the interaction between the deflection section and the protrusion and/or finger.

The engagement part is movable in the direction of the central axis relative to the carrier part. In a particularly preferred embodiment, a guide is provided, which restricts movement of the engagement section relative to the carrier part to movement in the direction of the central axis. This makes it possible to ensure that the movement of the engagement section relative to the carrier part will take place exactly in the direction which permits a good interaction of the deflection surface with the protrusion on the carrier part and/or with the finger of the engagement section. Such a guide can be achieved in particular preferably by a guide surface which is aligned parallel with the central axis. Such a guide surface may be provided, for example, on the engagement section and may cooperate with the edge of a hole designed as part of the carrier part. In a preferred specific embodiment, if such a hole is designed as rectangular in the carrier part, then an engagement section, which is also designed to have a rectangular cross section over a certain longitudinal extent, with three or even four of its then total of four surfaces (if the hole is designed as a slot) forming a right angle to one another, for example, so that the engagement section is moved along the central axis relative to the carrier part.

However, guidance of the movement of the clip part relative to the carrier part can also be achieved by means of guide surfaces designed at a distance from one another. A preferred specific embodiment of a clip part with two engagement sections is described further below. In one such specific embodiment, for example, two opposing guide surfaces may be provided, for example, on the carrier part, wherein the one guide surface guides a surface of the first engagement section and the second guide surface guides the second engagement section. Tilting can be prevented by the surface contact. The engagement section extends in the direction of a central axis away from the carrier part. Within the context of this description and the claims, the “central axis” is understood to be not only an axis passing through the gravity midpoint of the clip part and/or the gravity midpoint of the carrier part. The use of the term “central axis” should initially indicate only that this axis tends to run in the interior of the carrier part and/or of the clip part in most of the conceivable specific embodiments.

With the device according to the invention, a deflection surface is provided on the engagement section. The engagement section of the clip part may be an elongated section of the clip part which extends parallel to the central axis in the first region and at an angle to the central axis in another section. The deflection surface may be provided in this region. Likewise the engagement section may be an element of the clip part that is designed to be solid and has a longitudinal axis extending parallel to the central axis. A deflection surface standing at an angle to the central axis may be embodied in an end region of such an engagement section, which is designed to be solid, so that the engagement section tapers toward this end (its cross section is reduced). Clips created by cutting sheet metal to length and bending it are used in many possible fields of use of the device according to the invention. The deflection surface on the engagement section can therefore also be designed so that the engagement section is a sheet metal strip and the deflection surface is formed on one flag of the sheet metal strip, which has been bent relative to the sheet metal strip. The deflection surface may then be formed by one of the narrow side surfaces of the flag, which has been designed accordingly to be geometrically suitable. In one such specific embodiment, the main surface of the flag (top side and bottom side of the flag) may be used as a guide surface for guiding the movement of the clip part relative to the carrier part.

In the variant of the device according to the invention, which is described as the first, the carrier part has a protrusion which cooperates with the deflection surface on the engagement section. It is conceivable for the carrier part to be designed to be relatively solid and to have a protrusion formed on it, for example, in the form of an edge or a lip. This edge or lip may then border a hole in the carrier part into which the clip part partially protrudes. This protrusion of the clip part into the hole in the carrier part may also be used, for example, to connect the clip part to the carrier part. If a protrusion is provided in the part of the clip part that protrudes into the hole in the carrier part and this protrusion extends beyond the cross section of the hole in the carrier part and thus reaches beneath this part of the carrier part, then it is possible to prevent the clip part from being pulled out of the hole in the carrier part. The protrusion on the carrier part which cooperates with the deflection surface on the engagement section must not however be designed as an edge or lip of a component that is designed to be solid. The protrusion may also be designed as a finger or a web or a rib. Likewise—as already addressed above—the protrusion itself may be a surface running at an angle to the central axis so that two surfaces running at an angle to the central axis will slide over one another when the engagement section is moved relative to the carrier part in the direction of the central axis.

In the variant of the device according to the invention described as being the second, the clip part has a protrusion which is referred to as a “finger” for the sake of a better reference, this protrusion cooperating with the deflection surface on the carrier part. It is conceivable that the carrier part is designed to be relatively solid, and the deflection surface on it is embodied, for example, as connected to an opening or as the base of a recess. The clip part may then protrude into the opening and/or the recess. This protrusion of the clip part into the hole in the carrier part may also be utilized, for example, to connect the clip part to the carrier part. If a protrusion is provided in the part of the clip part protruding into the hole in the carrier part, this protrusion extending beyond the cross section of the hole in the carrier part and thus engaging behind this part of the carrier part, then it is possible to prevent the clip part from being pulled out of the hole in the carrier part. The protrusion on the engagement section cooperating with the deflection surface on the carrier part may be embodied as an edge or a lip. The protrusion may also be embodied as a finger or a web or a rib. Likewise—as already indicated above—the protrusion itself may be a surface running at an angle to the central axis so that two surfaces running at an angle to the central axis slide against one another when the engagement section is moved in the direction of the central axis relative to the carrier part.

With the device according to the invention, the sliding of the protrusion and/or the finger on the deflection surface causes a movement of the clip surface connected to the engagement section in the direction of the central axis or away from the central axis. A movement of the clip surface toward the central axis is expedient in particular in the specific embodiments in which the device according to the invention is provided to extend through a hole in the component to be restrained, and the clip surface should be moved back into the region of the hole for loosening the connection. A movement of the clip surface away from the central axis is expedient in particular in the specific embodiments in which the device according to the invention is provided for reaching around a component from the outside and moving the clip surface away from the component to loosen the connection. In these cases, if the carrier part is situated beneath the component and if the central axis passes through the component, then the clip surface must be moved away from the central axis in order to loosen the connection.

In a preferred specific embodiment, a mating surface together with the clip surface forms a gap on the engagement section to receive the component. This specific embodiment is preferred when the component is not only to be restrained in one direction but is also not to be moved in the opposite direction relative to the base body and/or the carrier part connected to the base body. By providing a mating surface, the movement of the component in the opposite direction can be prevented.

In a preferred specific embodiment, the engagement section is prestressed in a direction, which is opposite the direction of movement of the clip surface, which is induced when the protrusion is sliding along the deflection surface when the engagement section is moved relative to the carrier part in the direction of the central axis. The device according to the invention should restrain a component. To this end, it is essential for the clip surface to remain securely in the position (the normal position) in which it manifests its restraining effect. At the same time, the invention should make it possible to release the connection between the component and the base body, to which end the invention makes use of the fact that a movement of the clip surface in the direction of the central axis or away from the central axis can be induced by a relative movement of the engagement section relative to the carrier part and the interaction of the deflection surface with the protrusion and/or with the finger, and thus a movement of the clip surface out of the position in which it securely restrains the component [can be induced or is achieved]. To now prevent any threat to the desired secure restraining effect of the component in the normal position due to this additional function of the releasability of the connection, it is provided in a particularly preferred specific embodiment that the normal position in which the clip surface restrains the component well is the preferred position of the engagement section. At the same time, this means that the movement of the protrusion on the carrier part along the deflection surface and/or the movement of the finger of the engagement section along the deflection surface and thus the resulting movement of the clip surface in the direction toward the central axis or away from the central axis should take place against the resistance of a prestress. This can make it difficult to separate the connection. However, this appears to be acceptable if a secure restraining effect of the component in the normal position is facilitated in this way. This prestress can be achieved by the fact that the clip part has a rigid part which can be moved in a translational or rotational movement relative to the engagement section. A spring which prestresses the engagement section into a preferred position (the normal position) may be provided between the engagement section and the rigid part. Alternatively the rigid part and the engagement section may be part of the same element which is made of spring steel, for example, wherein the engagement section is a section that is bent toward the rigid part. If the section is bent out of this bent position again, then it springs back into the corresponding starting position.

In a particularly preferred specific embodiment, the rigid part of the clip part is the part of the clip part arranged closest to the carrier part, in particular preferably being part of the clip part engaging in a recess in the carrier part. In a preferred specific embodiment, the deflection surface is connected first along the engagement section in the direction away from the rigid part, in this order, and the portion of the engagement section to which the clip surface is connected then follows along the engagement section.

In a preferred specific embodiment, the engagement section is part of a spring element. The clip part can preferably be created from sheet metal by bending and punching in particular. If this sheet metal is made of spring steel, then the engagement section may extend as a bent part to a rigid part in its normal position. If the engagement section is bent out of this normal position relative to the rigid part, then it will spring back into the normal position.

In preferred specific embodiment, the clip part has a frame to which the engagement section is attached movably by a translational and/or rotational movement. The frame may have a rectangular section, for example, in which a rectangular recess is provided. Part of the frame may be a torsion rod to which the engagement section is connected so that the torsion rod can rotate and/or be pivoted relative to the frame. The frame may then additionally have holders which point at an angle from the rectangular section and to which the frame and therefore the clip part with the carrier part are connected. The engagement section is connected to the frame in such a way that the part to which the clip surface is connected is arranged on a different side of the frame than the part on which the deflection surface is arranged. A reversal of movement can be achieved due to the rotational connection of the engagement section to the frame. If the part of the engagement section connected to the deflection surface is moved away from the central axis by the cooperation of the protrusion with the deflection surface, then the part of the engagement section to which the clip surface is connected is moved toward the central axis. The torsion rod may be used to impart a prestress to the engagement section, forcing it into the normal position.

In a preferred specific embodiment, a recess in which the protrusion can engage after sliding at least along a portion of the deflection surface is provided on the deflection surface on the engagement section or at the edge of the deflection surface. This recess can be utilized to hold the engagement section in an unstable equilibrium in a position bent out of the normal position, despite being prestressed into the normal position. The recess can prevent the protrusion from sliding back on the deflection surface following the prestress of the engagement section when the force creating the movement of the engagement section relative to the carrier part in the direction of the central axis is eliminated. This makes is possible to achieve the result that the clip surface can be held in a surface that has moved out of its normal position. This allows handling of the component that has been held back relative to the device, for example, a pulling away or a renewed application of the component. Only after the protrusion has been moved out of the recess by applying additional force can the protrusion slide further along the deflection surface and back into the normal position, following the prestress on the engagement section.

In a preferred specific embodiment, a recess in which the protrusion (finger) can engage after sliding at least along a portion of the deflection surface is provided on the deflection surface on the carrier part or on the edge of the deflection surface. This recess can be utilized to hold the engagement section in an unstable equilibrium despite being prestressed into the normal position in a position in which it is curved out of the normal position. The recess can prevent the protrusion (finger) from sliding back, following the prestress of the engagement section, on the deflection surface when the force creating the movement of the engagement section relative to the carrier part in the direction of the central axis is eliminated. This makes it possible to achieve the result that the clip surface can be held in a surface that has been moved out of its normal position. This allows handling of the component that is held back relative to the device, for example, pulling off or renewed application of the component. Only after the protrusion has been moved out of the recess by application of additional forces can the protrusion slide back into the normal position further along the deflection surface following the prestress on the engagement section.

In a preferred specific embodiment the clip part according to the invention has a second clip surface. The second clip surface is connected to a second engagement section of the clip part, wherein the second engagement section extends away from the carrier part in the direction of the central axis, and wherein the second clip surface points at least essentially toward the carrier part. It is provided here that the second engagement section is movable relative to the carrier part in the direction of the central axis, and
a deflection surface is formed on the second engagement section and is aligned at an angle to the central axis, wherein the deflection surface contacts a second protrusion on the carrier part, and the second protrusion slides along the deflection surface when the second engagement section is moved toward the carrier part in the direction of the central axis so that a movement of the second clip surface connected to the second engagement section in the direction toward or away from the central axis is induced,
   and/or
a deflection surface is formed on the carrier part and is aligned at an angle to the central axis, wherein the deflection surface contacts a finger on the second engagement section, and the finger slides along the deflection surface when the engagement section is moved relative to the carrier part in the direction of the central axis, so that a movement of the clip surface connected to the second engagement section is induced in the direction of the central axis either toward or away from the central axis.

Providing two or more clip surfaces improves the restraint effect of the component. Furthermore, by providing two or more clip surfaces, it is possible to create a symmetry of the restraining forces and thus prevent tilting of the component to be restrained relative to the carrier part and/or relative to the base body. Furthermore, it is recommended that two clip surfaces be provided and therefore two engagement sections in order to also establish a symmetry of forces in the specific embodiments in which a prestressing of the engagement sections into a normal position is provided.

In a preferred specific embodiment, the clip part has a rigid part from which the two engagement sections extend. In particular preferably in this specific embodiment the first engagement section is a bent part of the rigid part on a first edge of the rigid part and the second engagement section is a bent part of the rigid part on a second edge, in particular preferably the first opposing edge of the rigid part. The clip component is therefore simple to produce.

In preferred specific embodiment, the first engagement section is prestressed into a normal position, and the second engagement section is prestressed into a normal position. In a preferred specific embodiment the prestressing force for the first engagement section acts in the opposite direction from the prestressing force for the second engagement section.

In a preferred specific embodiment, the clip part is designed to be in mirror symmetry with respect to a plane which contains the central axis and/or the carrier part is designed to be in mirror symmetry with respect to a plane containing the central axis. The design of the clip part and/or of the carrier part in mirror symmetry simplifies the construction of the device according to the invention. At the same time the mirror symmetrical design of the clip part and/or of the carrier part offers the possibility of forming holding forces and also prestressing forces in symmetry with one another.

In a preferred specific embodiment the carrier part has a flat contact surface for applying the carrier part, in particular for welding or gluing the carrier part onto a base body.

In a preferred specific embodiment, the clip surface and the engagement section are shaped in one piece. The clip surface is in particular preferably a surface of a bent part of an engagement section.

In a preferred specific embodiment, the carrier part and/or the clip part is/are made of metal. The carrier part and/or the clip part is/are in particular preferably created by bending a sheet metal section punched into a suitable shape. It has been found that such clips may be used in particular as permanent restraints for components.

The device according to the invention is used in particular in the following fields: fastening insulation material, in particular sheets of insulation material, fastening underfloor covers and/or fastening protective sheet metal and/or mud guards.

The invention is explained in greater detail below on the basis of drawings which illustrate exemplary embodiments of the invention in greater detail, in which:

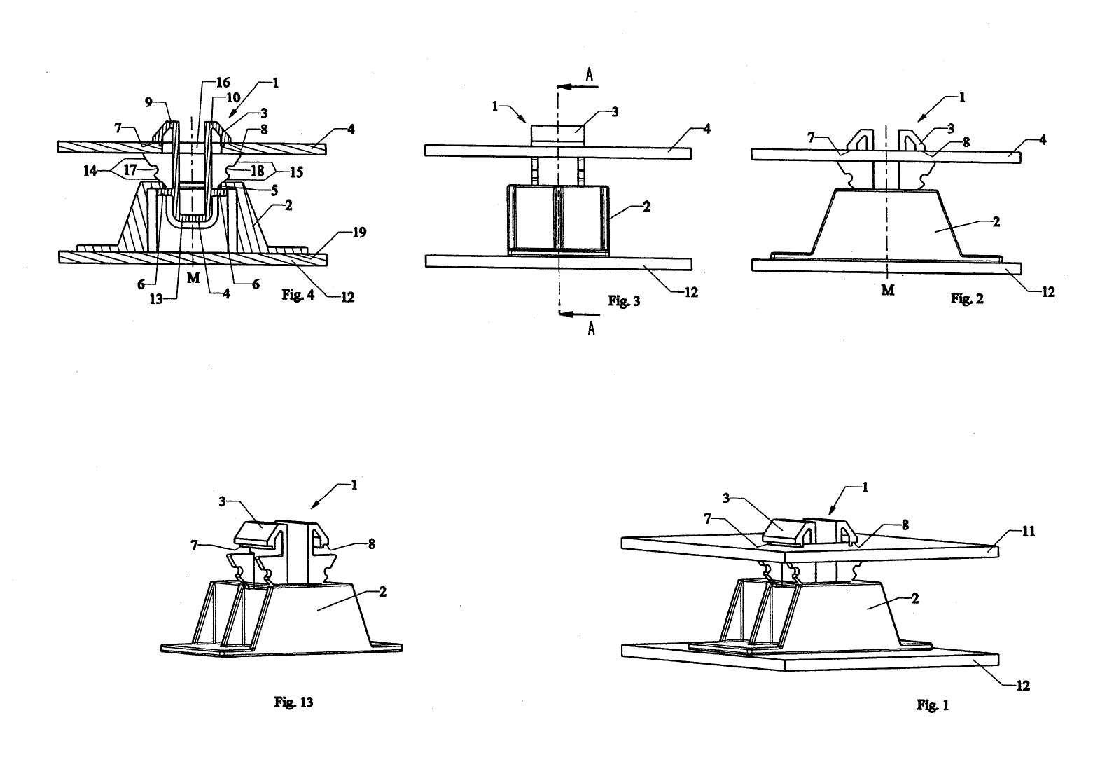

FIG. 1 shows a perspective view of a first specific embodiment of the device according to the invention, as mounted on a base body and restraining a component relative to the base body,

FIG. 2 shows a first side view of the device according to FIG. 1,

FIG. 3 shows a second side view of the device according to FIG. 1 and

FIG. 4 shows a sectional view along line A-A in FIG. 3,

FIG. 5 shows a perspective view of a second specific embodiment of the device according to the invention, as mounted on a base body and restraining a component relative to the base body,

FIG. 6 shows a side view of the device according to FIG. 5,

FIG. 7 shows a second side view of the device according to FIG. 5 and

FIG. 8 shows a sectional view along the line B-B in FIG. 7,

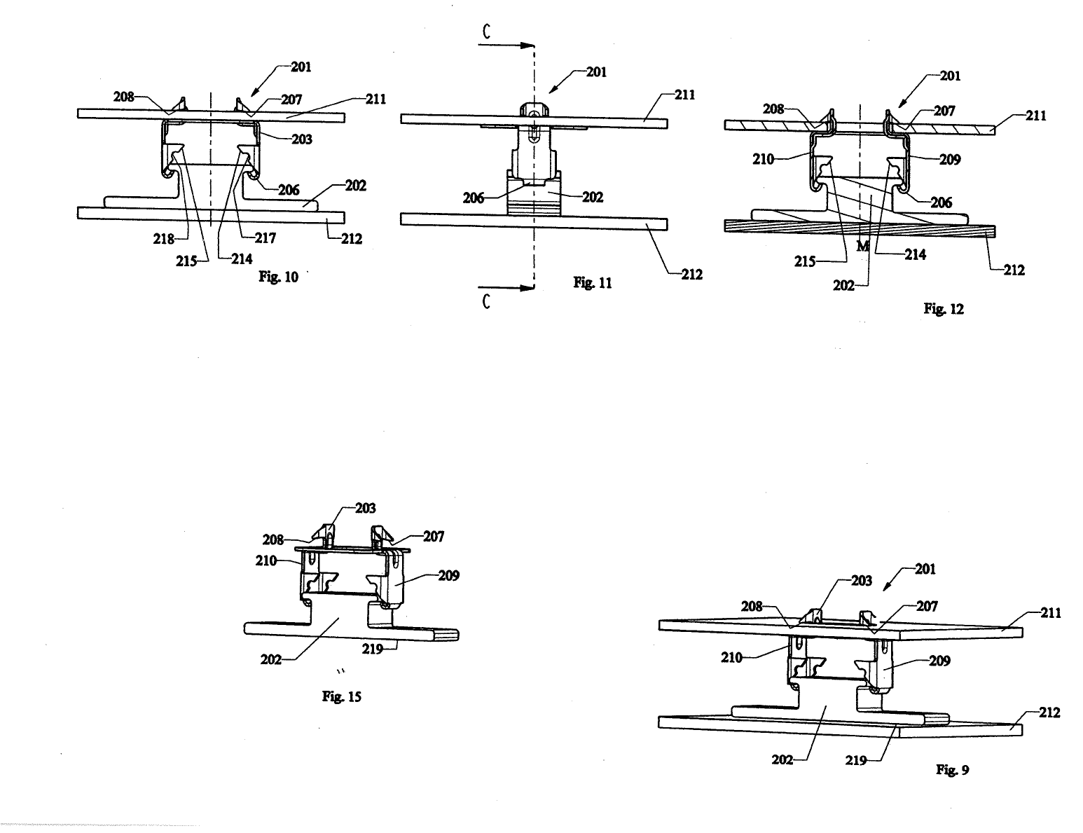

FIG. 9 shows a perspective view of a third specific embodiment of the device according to the invention, as mounted on a base body and restraining a component relative to the base body,

FIG. 10 shows a first side view of the device as shown in FIG. 9,

FIG. 11 shows a second side view of the device as shown in FIG. 9,

FIG. 12 shows a sectional view along the line A-A in FIG. 11, and

FIG. 13 shows a perspective view of the device according to the invention as shown in FIGS. 1 through 4,

FIG. 14 shows a perspective view of the device according to the invention as shown in FIGS. 5 through 8 and

FIG. 15 shows a perspective view of the device according to the invention as shown in FIGS. 9 through 12.

FIGS. 1 through 4 and 13 show a first specific embodiment of the device 1 according to the invention in its installed state. The device 1 has a carrier part 2 and a clip part 3. The clip part 3 is connected to the carrier part 2. A lower end 4 therefore passes through an opening 5 into the interior of the carrier part 2. Protrusions 6 on the clip part 3 engage behind the edge of the opening 5 on the carrier part. This prevents the clip part 3 from being movable along the central axis M away from the carrier part 2. This results in the connection between the clip part 3 and the carrier part 2. At the same time however this connection makes it possible for the clip part 3 to be moved toward the carrier part 2 in the direction of the central axis M, i.e., in the opposite direction.

The clip part 3 has a first clip surface 7 and a second clip surface 8. The first clip surface 7 is connected to a first engagement section 9, namely due to the fact that the sheet metal section forming the first engagement section is bent on its end. Therefore the clip surface 7 is formed, facing at least essentially toward the carrier part 2. The second clip surface 8 is connected to a second engagement section 10 in a comparable manner, namely by bending over the sheet metal section formed by it. The second clip surface 8 also points essentially toward the carrier part 2.

As can be seen in FIGS. 1 through 4, the first clip surface 7 and the second clip surface 8 serve to restrain a component 11 relative to a base body 12. As will be described in greater detail below, the carrier part 2 is connected to the base body 12. Since the clip part 3 is connected to the carrier part 2 and the first clip surface and the second clip surface face essentially toward the carrier part 2 and thus toward the base body 12, they prevent movement of the component 11 away from the base body 12 and along the central axis M and thereby restrain the component 11 in relation to the base body 12.

The clip part 3 has the first engagement section 9 and the second engagement section 10. These extend from the rigid part 13 of the clip part 3 forming the lower end 4 in the direction of the central axis M. The first engagement section 9 and the second engagement section 10 therefore also extend away from the carrier part 2 in the direction of the central axis M. The first engagement section 9 and the second engagement section 10 are sheet metal sections created by bending a portion of a larger sheet metal section, comprising the rigid part 13, the first engagement section 9 and the second engagement section 10. The clip part 3 is converted to a spring element by the bending operation. The first engagement section 9 is prestressed to the left in the view in FIG. 4. If it is bent to the right in relation to the rigid part 13 in the view according to FIG. 4, this would require a force with which the prestress would have to be overcome. When the first engagement section 9 is released, it recoils back into the normal position illustrated in FIG. 4. The second engagement section 10 is then prestressed to the right in the view according to FIG. 4. If it is bent to the left in relation to the rigid part 13 in the view according to FIG. 4, this would require a force with which the prestress would have to be overcome. When the second engagement section 10 is released, it recoils back into the normal position illustrated in FIG. 4.

The specific embodiment illustrated in FIGS. 1 through 4 shows a first variant of the device according to the invention, in which a first deflection surface 14 is provided on the first engagement section 9, and a second deflection surface 15 is provided on the second engagement section 10. The deflection surfaces 14 and 15 are aligned at an angle to the central axis M. These surfaces are created by making a 90° bend in the sheet metal section forming the respective engagement section. The deflection surfaces 14, 15 are then formed by the surface of the narrow side of the flag bent in this way.

As shown in FIG. 4 in particular, the deflection surfaces 14, 15 each contact a protrusion on the carrier part 2. The protrusion is provided through the edge bordering the opening 5. The edge of the opening 5 slides along the respective deflection surface 14, 15 when the respective engagement section 9, 10 is moved toward the carrier part 2 in the direction of the central axis. Since the edge of the opening 5 is designed to be rigid, the movement of the engagement sections 9, 10 toward the carrier part 2 causes the flags having the deflection surfaces 14, 15 and the engagement sections 9, 10 with the former to be moved toward the central axis M. In doing so the prestressing force holding the engagement sections 9 and 10 in the normal positions illustrated in FIG. 4 is overcome. Since the first clip surface 7 is connected to the first engagement section 9, and the second clip surface 8 is connected to the second engagement section 10, the movement of the engagement sections 9 and 10 toward the central axis M causes the clip surfaces 7, 8 connected to the engagement sections 9, 10 to be moved toward the central axis M.

The clip part 3 can be moved toward the carrier part 2 until the resulting movement of the protrusions along the deflection surfaces 14, 15 and the associated movement of the clip surfaces 7, 8 onto the central axis M goes so far that the clip surfaces 7, 8 lose their contact with the component 11 to be restrained and they are thus entirely within the hole 16 inside the component 11. It is thus possible to release the connection between the component 11 to be restrained and the base body 12. The component 11 can then be removed. This removal of the component 11 is facilitated by the fact that recesses 17, 18, in which the respective protrusions on the carrier part 2 can engage, are provided in the deflection surfaces 14, 15. The recesses 17, 18 are designed to be so deep that the protrusions can no longer slide back along the respective deflection surfaces 14, 15 even if the prestress in the engagement sections 9 and 10 attempts to bring about such a movement. In this position of an unstable equilibrium, the clip surfaces 7, 8 are held in the compressed position. This permits easy removal and renewed displacement of a component 11. After renewed displacement of the component 11, the protrusions can be removed from the recesses 17 and 18 by manually moving the clip part 3, so that they can slide back along the deflection surfaces 14, 15 and in this way the device returns back to the normal position illustrated in FIG. 4.

As can be seen in FIG. 4 that a mating surface which together with the respective clip surface 7 and/or 8 forms a gap to receive the component 11 is firmed on the flag which provides the deflection surface 14 and/or 15 respectively. In this way the component 11 can be securely connected to the clip part 3 and moves with the clip part 3 when the latter is moved.

The figures show that both the clip part 3 and the carrier part 2 are designed in mirror symmetry with respect to a plane which contains the central axis M and runs at a right angle to the plane of the paper in FIGS. 2 and 4.

The carrier part 2 has a flat contact surface. The carrier part 2 can be welded well to the base body 12 with this contact surface.

With the specific embodiment illustrated in FIGS. 5 through 8 and 14, components which are identical in function to the components in the specific embodiment described with reference to FIGS. 1 to 4 are labeled with the same reference numerals that have been increased by the value 100. Only the functional differences between the two specific embodiments are described below.

Instead of the protrusions 6 formed on the clip part in the design in FIGS. 1 through 4, a restraint element 120 is provided in the specific embodiments in FIGS. 5 through 8. This restraint element 120 is a section of the sheet metal element forming the carrier part 2, said section being bent inward into the hole 105. On its lower end, the restraint element 120 has a restraining surface 121, which cooperates with the rigid part 113, forming the lower end 4 of the clip part 103, and prevents the rigid part 113 and thus the entire clip part 103 from being able to move away from the carrier part 102 in the direction of the central axis M.

As shown in the perspective view in FIG. 5 in particular, but also as shown in FIG. 7, each engagement section 109, 110 of the specific embodiment according to FIGS. 5 through 8 has two clip surfaces 107, 108, namely outwardly curved flags 122, are provided on the edges of the respective engagement section. The surface of the respective flag 122 facing the carrier part 102 forms a first clip surface on the first engagement section 109 and forms a second clip surface 108 on the second engagement 110.

As shown in FIG. 8, the sheet metal element formed in the first engagement section 109 and/or in the second engagement section 110 is bent back at its end at a distance from the carrier part 102 and thus forms a rounded part facilitating placement of the component 111 on the clip part.

The structural design in FIGS. 5 through 8 differs from that in FIGS. 1 through 4 in particular in that the deflection surfaces 114 and 115 are formed on the carrier part 102 here. To do so, bent flags 123 having the deflection surfaces 114, 115 on their side surface are provided on the sheet metal element forming the carrier part 102. Fingers 124 are formed on the clip part 103. These fingers 124 of the engagement sections 109, 110 contact the deflection surfaces 114, 115. The fingers 124 slide along the deflection surfaces 114, 115 when the engagement section 109, 110 is moved relative to the carrier part 102 in the direction of the central axis M. Since the carrier part 102 and the total of four flags 123 provided on it are rigidly formed with the respective two first deflection surfaces 114 and the respective two second deflection surfaces 115, so movement of the fingers 124 along the deflection surfaces 114 and 115 results in the engagement sections 109 and 110 that are connected to the rigid part 113 with a spring action are moved inward toward the central axis M. Since the clip surfaces 107 and 108 are connected to the engagement sections 109 and 110, the clip surfaces 107 and 108 are therefore also moved toward the central axis M.

In the specific embodiment according to FIGS. 5 through 8, the mating surfaces opposite the clip surfaces 107 and 108 are formed by curved elements 125 of the clip part 103. In the specific embodiment illustrated in FIGS. 9 through 12 and 15, components similar in function to components from the specific embodiment described with respect to FIGS. 1 through 4 are labeled with the same reference numerals that have been increased by the value 200. In the following discussion, only the functional differences between the two specific embodiments are described.

The exemplary embodiment illustrated in FIGS. 9 through 12 differs from the preceding exemplary embodiment mainly in the design of the clip part 203. Whereas in the specific embodiments in FIGS. 1 through 4 and 5 through 8, the clip part is fundamentally designed according to a U-shaped component with the rigid part 13, 113 as the base and the engagement sections 9, 109 and/or 10, 110 as the legs with additional elements which are created by bending and protrude away from this basic shape, so that the clip part 203 of the specific embodiment according to FIGS. 9 through 12 is designed in two parts. The clip part 203 has a frame 230. The mating surface to the surfaces 207 and 208 and the protrusions 206 which engage behind the protrusions on an anvil-type part of the carrier part 202 are formed on this frame. The engagement sections 209 and 210 are designed to be pivotable with respect to this frame 230. To this end, the frame has a torsion rod 231. The respective engagement section 209 and/or 210 can be pivoted about the longitudinal axis relative to the frame 230.

On the first engagement section 209, two first deflection surfaces 214 are formed with their recess 217 by flags that are bent at the edges. Two bent flags are provided at the edge of the opposing end of the first engagement section 209, with a total of two first clip surfaces 207 formed on the side surfaces. The second engagement section is designed in a comparable way and has flags on which the second deflection surfaces 215 with their recesses 218 are formed, like the flags on whose side surfaces the two second clip surfaces 208 are formed.

The protrusions 206 restrain the frame 230 only to prevent movements along the central axis M in the direction away from the carrier part 202. However, the frame 230 and thus the entire clip part 203 may be moved further along the central axis M toward the carrier part 202. In doing so the protrusions formed on the anvil-type part of the carrier part 202 slide along the deflection surfaces 214 and 215. Therefore, they rotate the engagement sections 209 and 210 about the axis of rotation of the torsion rods 231 opposite the restoring force of the torsion rods 231 about the axis of rotation of the torsion rods 231. Therefore, the movement of end of the respective engagement section 209, 210 that is closer to the carrier part 202 and away from the central axis M becomes a movement of the clip surface 207, 208 provided on the opposing end of the respective engagement section 209, 210 and a movement toward the central axis M.

1. A device for retaining a component, wherein the device comprises a carrier part and a clip part, the clip part being connected to the carrier part and the clip part including at least one clip surface that is connected to an engaging portion of the clip part, wherein the engaging portion extends in the direction of a central axis away from the carrier part and wherein the clip surface at least largely points toward the carrier part, characterized in that the engaging portion comprises a fulcrum that is located between the clip surface and the carrier part such that the clip surface laterally moves toward the central axis when a portion of the engaging portion, which is arranged between the fulcrum and the carrier part, is moved laterally away from the central axis.

2. The device according to claim 1, characterized in that the engaging portion is connected to a torsion bar, which is located between the clip surface and the carrier part, and which forms the fulcrum of the engaging portion, wherein the torsion bar is a part of the clip part.

3. The device according to claim 1, characterized in that the fulcrum is movable relative to the carrier part and
a deflector is provided on the second engaging portion, wherein the deflector is located in the space between the fulcrum and the carrier part, and is oriented at an angle to the central axis, wherein the deflector makes contact with a protrusion on the carrier part and the protrusion glides along the deflector when the fulcrum is moved in the direction of the central axis relative to the carrier part, which causes a lateral movement of a portion of the engaging portion, which is located between the fulcrum and the deflector, toward the central axis or away from the central axis;
and/or
a deflector is provided on the carrier part and oriented at an angle to the central axis, wherein the deflector makes contact with a finger on the engaging portion, wherein the finger is located on the engaging portion in the space between the fulcrum and the carrier part, and the finger glides along the deflector when the fulcrum is moved in the direction of the central axis relative to the carrier part, which causes a lateral movement of a portion of the engaging portion, which is located between the fulcrum and the deflector, toward the central axis or away from the central axis.

4. The device according to claim 1, characterized by an opposing surface on the engaging portion, which together with the clip surface forms a slot to receive the component.

5. The device according to claim 1, characterized in that the portion of the engaging portion that comprises the clip surface is preloaded in a direction away from the central axis.

6. The device according to claim 5, characterized in that the engaging portion is part of a spring element.

7. The device according to claim 1, characterized in that an indentation is arranged on the deflector on the engaging portion or at the edge of the deflector, in which the protrusion can engage after it has glided along at least a portion of the deflector.

8. The device according to claim 1, characterized in that the clip part comprises a second clip surface, which is connected to a second engaging portion of the clip part, wherein the second engaging portion extends away from the carrier part in the direction of the central axis and wherein the second clip surface at least largely points toward the carrier part, characterized in that the second engaging portion comprises a second fulcrum, which is located between the second clip surface and the carrier part, such that the second clip surface moves laterally toward the central axis when a portion of the second engaging portion, which is located between the fulcrum and the carrier part, is moved laterally away from the central axis.

9. The device according to claim 8, characterized in that the second engaging portion is connected to a torsion bar, which is located between the second clip surface and the carrier part, and which forms the second fulcrum of the second engaging portion, wherein the torsion bar is a part of the clip part.

10. The device according to claim 8, characterized in that the second fulcrum is movable relative to the carrier part and movable in the direction of the central axis relative to the carrier part, and
a deflector is provided on the second engaging portion, wherein the deflector is located in the space between the second fulcrum and the carrier part, and is oriented at an angle to the central axis, wherein the deflector makes contact with a second protrusion on the carrier part and the second protrusion glides along the deflector when the second fulcrum is moved in the direction of the central axis relative to the carrier part, which causes a lateral movement of a portion of the second engaging portion, which is located between the second fulcrum and the deflector, toward the central axis or away from the central axis;
and/or
a deflector is provided on the carrier part, wherein the finger is located on the engaging portion in the space between the second fulcrum and the carrier part and oriented at an angle to the central axis, wherein the deflector makes contact with a finger on the second engaging portion, and the finger glides along the deflector when the second fulcrum is moved in the direction of the central axis relative to the carrier part, which causes a lateral movement of a portion of the second engaging portion, which is located between the second fulcrum and the deflector, toward the central axis or away from the central axis.

11. The device according to claim 1, characterized in that the clip part is arranged mirror-symmetrically with regards to a plane that comprises the central axis and/or that the carrier part is arranged mirror-symmetrically with regards to a plane that comprises the central axis.

12. The device according to claim 1, characterized in that the carrier part comprises a flat mating surface for mounting purposes, in particular to weld the carrier part to a base body.

13. The device according to claim 1, characterized in that the clip surface and the engaging portion are made of a single piece.

14. The device according to claim 1, characterized in that the carrier part and/or the clip part are made of metal.

15. The device according to claim 1, characterized by a wedge, which is located within the clip part, specifically in the space between the fulcrum and the carrier part and which is movable relative to the engaging portion, wherein
a. a deflector is provided on the engaging portion, wherein the deflector is located in the space between the fulcrum and the carrier part, and is oriented at an angle to the central axis, wherein the deflector makes contact with the wedge and the wedge glides along the deflector when the wedge is moved in the direction of the central axis relative to the deflector, which causes a lateral movement of a portion of the engaging portion, which is located between the fulcrum and the deflector, toward the central axis or away from the central axis.

16. The device according to claim 15, characterized in that the wedge is made of ferromagnetic material.

17. The device according to claim 2, characterized in that the fulcrum is movable relative to the carrier part and
a deflector is provided on the second engaging portion, wherein the deflector is located in the space between the fulcrum and the carrier part, and is oriented at an angle to the central axis, wherein the deflector makes contact with a protrusion on the carrier part and the protrusion glides along the deflector when the fulcrum is moved in the direction of the central axis relative to the carrier part, which causes a lateral movement of a portion of the engaging portion, which is located between the fulcrum and the deflector, toward the central axis or away from the central axis;
and/or
a deflector is provided on the carrier part and oriented at an angle to the central axis, wherein the deflector makes contact with a finger on the engaging portion, wherein the finger is located on the engaging portion in the space between the fulcrum and the carrier part, and the finger glides along the deflector when the fulcrum is moved in the direction of the central axis relative to the carrier part, which causes a lateral movement of a portion of the engaging portion, which is located between the fulcrum and the deflector, toward the central axis or away from the central axis.

18. The device according to claim 2, characterized by an opposing surface on the engaging portion, which together with the clip surface forms a slot to receive the component.

19. The device according to claim 2, characterized in that the portion of the engaging portion that comprises the clip surface is preloaded in a direction away from the central axis.

20. A device for retaining a component, wherein the device comprises a carrier part and a clip part, the clip part being connected to the carrier part and the clip part including at least one clip surface that is connected to an engaging portion of the clip part, wherein the engaging portion extends in the direction of a central axis away from the carrier part and wherein the clip surface at least largely points toward the carrier part, characterized in that the engaging portion comprises a fulcrum that is located between the clip surface and the carrier part such that the clip surface laterally moves toward the central axis when a portion of the engaging portion, which is arranged between the fulcrum and the carrier part, is moved laterally away from the central axis, the device further comprising a torsion bar positioned between the clip surface and the carrier part, the engaging portion being connected to the torsion bar.
